(19) United States
(12) Patent Application Publication
(10) Pub. No.: US 2023/0148617 A1
(43) Pub. Date: May 18, 2023

(54) Three Drawer Gill and Smoker with Fire, Water and Ash Management Systems

(71) Applicant: Douglas Christopher Moore, Pearl, MS (US)

(72) Inventor: Douglas Christopher Moore, Pearl, MS (US)

(21) Appl. No.: 17/803,175

(22) Filed: Oct. 11, 2021

(51) Int. Cl. A23B 4/052; F24B 13/02; A47J 37/07

(52) U.S. Cl. CPC A23B 4/0523; A47J 37/0704; A47J 37/0786; F24B 13/02

(57) ABSTRACT

A smoker grill with separately accessible drawers for managing steam, smoke, combustion and ash while maintaining the cooking process without having to remove the food product from the racks, optimizing cook time, decreasing the likelihood of food contamination, and making cleanup simple and easy. The grill includes a cooking chamber with racks, with a half cylinder top and box shaped lower compartment with three drawers containing a removable liquid or water box with an interconnected V-channels for creating steam and collecting drippings and allowing heat to pass through to cook food items, a removable fire box with a perforated metal floor for burning solid fuels (charcoal, wood, etc.), and a removable ash box (ash collection drawer) for collecting residuals of burnt solid fuel. The perforated floor allows air to flow up into the combustion chamber while allowing ashes to drop down away and out of the combustion chamber into the ash drawer.

### FIELD OF THE INVENTION

The invention relates to an outdoor barbeque smoker/grill for slow cooking of meats and other food items over an open solid fuel fire with solid fuel, fluid and ash management systems that impart the smokey yet moist flavor and texture required for great barbeque.

### BACKGROUND OF THE INVENTION

In a conventional smoker or grill, the grill is heated by gas, coal, or wood. A coal burning grill or smoker usually requires that the user remove the grill grates to gain access to the coal pan or fire box (combustion chamber) or area of the grill or smoker to light a fire and begin the process of grilling. Ash from burning the solid fuel usually builds up in the fire pan as the solid fuel (e.g. coals, wood chips, etc.) usually causing the solid fuel to burn quicker or deprive some of the solid fuel of oxygen causing cold spots in the fire box and the grill or smoker.

Water or other liquids are usually added to keep the flame down and to add moisture to food items using a spray bottle, an improvised drip container or adding a container of liquid to the fire box to achieve the steam and moisture needed for proper smoking and cooking without drying out the meat or food product. Adding water manually can put out the flame and cause cold spots within the grill or smoker. Once the fire is lit the cook usually has to replace the grates and then add the meats and food items to the grill then close the top and allow the grill to obtain the proper temperature for grilling and smoking.

In addition, when coals go out (stop burning) in the middle of cooking, the cook usually has to open the grill cover or top, remove the meat and food items from the grill grates, remove the grates which are usually very hot and dangerous, add more solid fuel to the grill, possible even remove ashes during the process, and basically repeat the grilling or smoking process all over again. Meanwhile, the meats and food items temperatures drop or decrease causing the possible growth of bacteria, insect contamination and moisture loss. Food items may also fall into the ashes and the closeness of the fire to the food item often causes the food item to burn or become overcooked without constant monitoring by the cook.

### SUMMARY OF THE PRESENT INVENTION

This invention eliminates the problems experienced when using most conventional grills and smokers with respect to having to add fuel or liquid and to remove food items to access key parts of the grill or smoker. It also addresses the issue of ash management and removal during the cooking process. This invention allows the grilling and smoking process to continue without the interruptions that might normally contribute to undercooking, overcooking, drying or food poisoning. This system also allows for the burning of larger pieces of split wood without burning the meats and food items.

The grill/smoker of the present invention is in the shape of a cabinet with a half barrel (semi-cylinder with semi-circular ends) top or lid creating a natural convection in which heat and smoke circulate continuously and thoroughly within the grill/smoker. The cabinet design provides separate drawers for liquid, solid fuel and ash management as well as separate management of food items and meats decreasing the likelihood of cross contamination and improper cooking. The water (liquid) reservoir also serves as a drip collector protecting the fire from drippings and allowing much of the meat drippings to be collected and disposed of. The distance of the fire box from the food item decreases the likelihood of overcooking or burning food items and meats and promotes a slower but more thorough outdoor cooking process that will likely produce a better overall grilling experience. No other grill/smoker provides the separate management of every resource used providing a continuous and safer grilling process.

### BRIEF DISCRIPTION OF THE DRAWINGS

FIG. 1 is a front view or elevation of the grill/smoker in accordance with the present invention.

FIG. 2 is a right-side view or elevation of the grill/smoker in accordance with the present invention.

FIG. 3 is a left side view or elevation of the grill smoker in accordance with the present invention.

FIG. 4 is a rear view or elevation of the grill/smoker in accordance with the present invention.

FIG. 5 is a bottom perspective view of the grill/smoker in accordance with the present invention.

FIG. 6 is a top/front/side three-dimensional perspective view of the grill/smoker in accordance with the present invention with the semi-cylindrical lid open showing the food support rack (grate), hinges and internal details of the three access drawers (liquid, solid fuel and ash management systems).

FIG. 7 is a perspective view of the liquid drawer (box) in which a liquid such as water may be added as part of the smoking process allowing smoke and heat to pass through the vents for more direct heat and vaporization of liquid. The water pan or drawer may also be designed with cylindrical or cone style holes instead of V-shaped vents.

FIG. 8 is a perspective view of the fire drawer (box) in which solid fuel such as coal, wood, wood chunks, wood chips, or such may be burned to provide a source of heat.

FIG. 9 is a perspective view of the ash collection and disposal drawer (box) from ashes that fall through the bottom of the perforated or screened fire box from the burning of solid fuels.

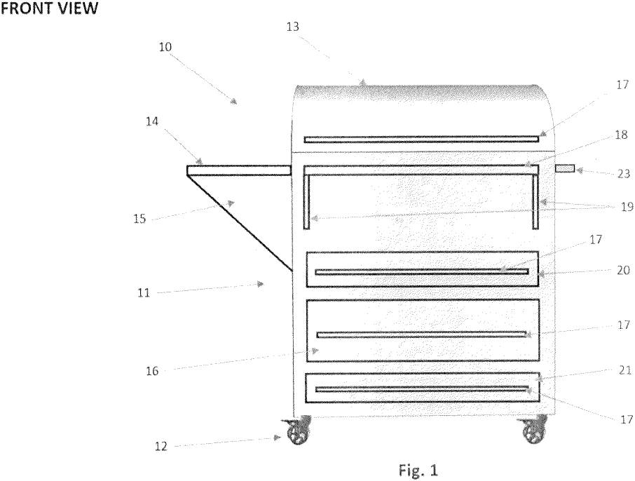

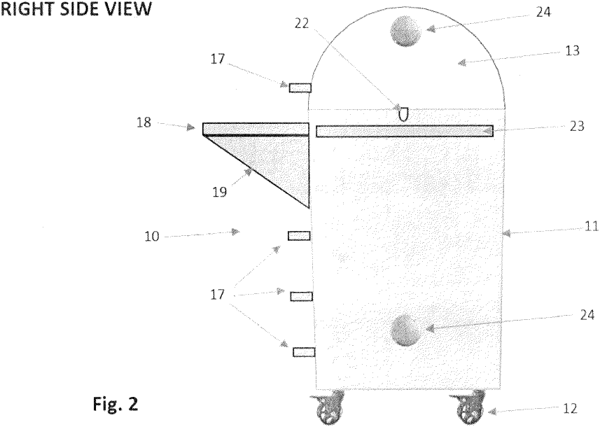

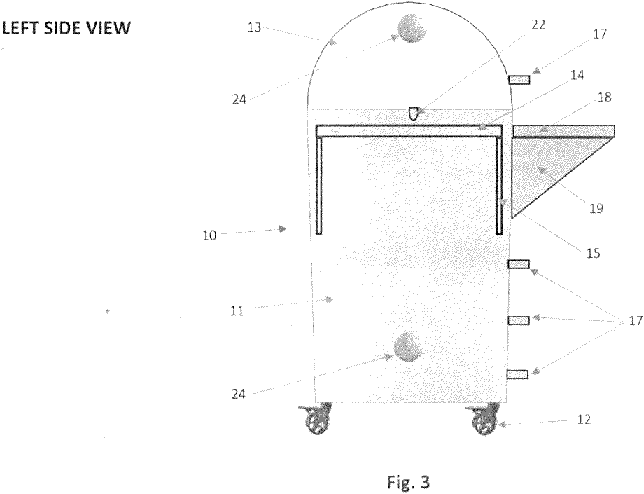

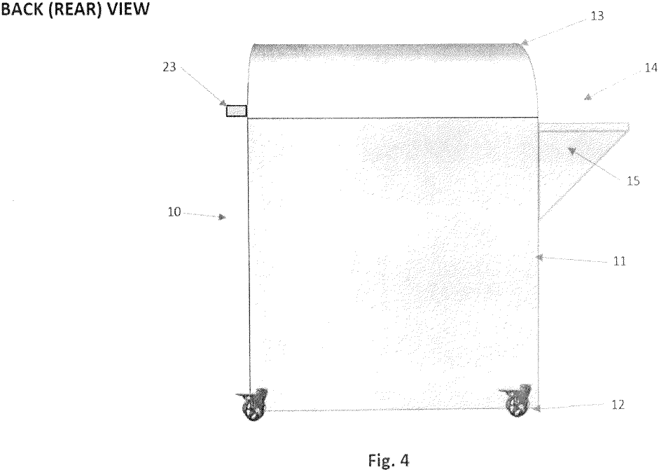

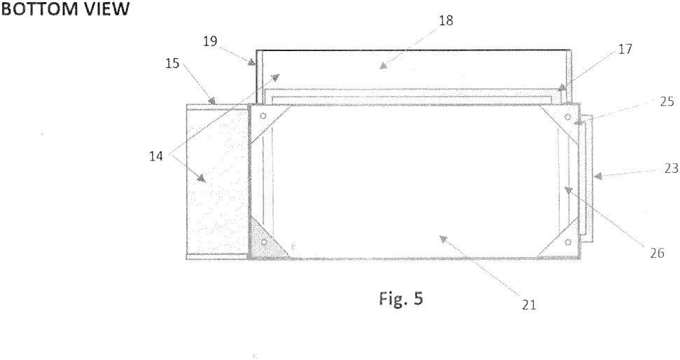

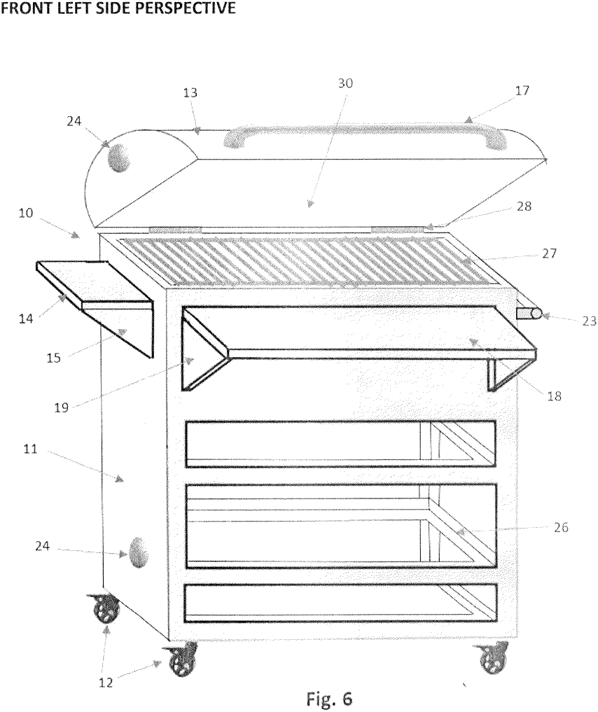

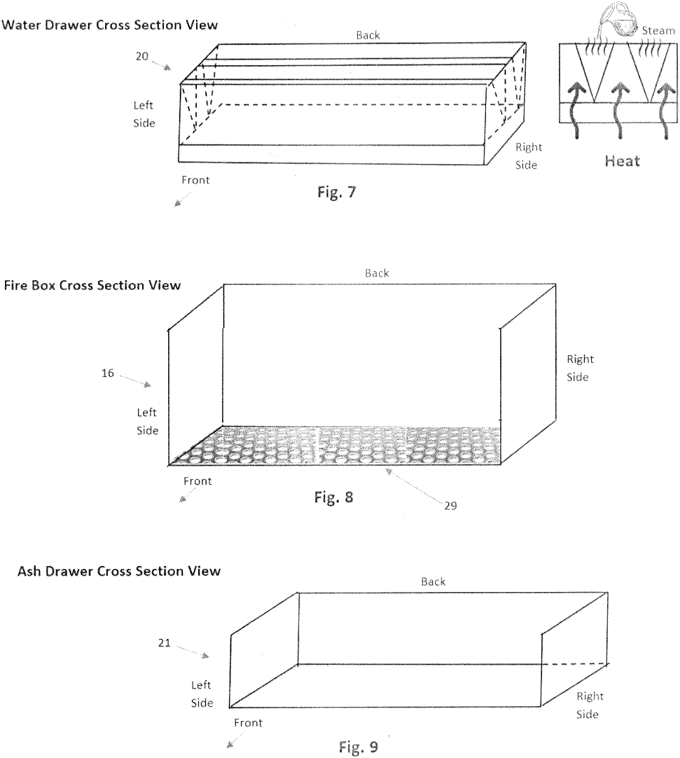

### DESCRIPTION OF THE RELATED ART

There exists a great quantity of prior art with respect to barbeque grills and smokers of various shapes, sizes, and other physical characteristics but none have the unique combination of liquid, fuel and ash management systems separate from the cooking area of the grill that allow users to easily access these systems without removing meats or food items from the cooking rack of the grill or smoker in order to access these components once the resources have been exhausted during the grilling or smoking process.

Cohen (US 10188120 B2) invented “a smoker with multiple (2) separate drawers for smoking meat, fish, sausage, etc., ...with sliding drawers enable the maintenance of a stable smoking temperature and offer a safer means to replenish water and/or wood during the actual smoking operation. The multiple drawers allow a user to add wood and/or water without opening the smoking chamber.” The smoker comprising of two drawers: one sliding drawer to hold water or liquid, and another drawer to contain smoking material such as wood or charcoal. His design also contained an ash holder which was not a sliding drawer but instead in the shape of a cannister or small drum.

The BBQ Oven invented by Wilbert C. Kuopus on 08/2001, patent number CA 02311363 presents the closest related art found which consist of a barbecue oven and chambers both mobile and stationary with “pivoting mounted trays”, “an upper smoker chamber”, “a lower fire chamber with a smoke generating compartment” “...configured to receive elongated pieces of wood” “..positioned above the gas fueled burners”, “..mounted on a wheeled chassis” and “an exterior catch pan... to catch grease and other fluids”.

However, Kuopus’ BBQ Oven by all appearances was enormous in size, consisted of pivoting mounted trays (rotisserie) instead of fixed position grates or a cooking surface and it was fueled by gas instead of coal briquettes. In addition, no component existed for the purpose of collecting and disposing of ashes since wood was not allowed to be completely combusted. There was also no component for heating water to create steam or moisture within the cooking chamber. Kuopus defended his 2001 patent application citing references for prior art with patent numbers, 5431093, 5205207, 5704278, 5163359, 4869163, 5528984, 4867051, 4086849 and 4108055. Based on Kuopus’ research, these prior arts are similar to his invention with respect to gas burners as a sole heating or cooking source, smoking of wood, grease collection and mobility. Kuopus′ 2001 patent (CA02311363) expired on or around Jun. 13, 2020 and has not been renewed or reapplied as of the date of the present invention and application for patent.

US 2001/0035176 A1 (Bush 11/2001) presented a BBQ Pit very similar in design with a removable fire box to facilitate cleanup. Bush’s invention used sliding oven doors and a fire box with water below the firebox to catch and extinguish ashes and embers from the grill. His design uses “a food grill, a fuel grill and a fire box that is removable...” [0008]. My design utilizes water to create steam and thus moisture that helps to cook and maintain moisture in meats.

US 2011/0120442 A1 (Duncan 5/2011) patented a BBQ grill and smoker with a single removable drawer in the center that can be filled with “wood, water or other substances”. There is no separate system of management for individual cooking or grill components. In addition, the design appears to be gas fueled and very different in from my invention and design.

US 2020/0242943 A1 (Laporta 9/2010) presents a burner-based gas grill on one side and a charcoal type grill on the other side with right and left side trays and a storage cabinet underneath the cooking chamber. US 8,381,712 B1 is similar with a gas burner on one side and what appears to be a charcoal burner on the other using a side-by-side dual barrel configuration but with no systems for the management of individual components without removing the food grates.

4,643,162 (Collins 2/1987) invented a BBQ Smoker with a single front access door. The fuel source is not evident but the apparatus contains a food shelf or rack a second box and what appears to be a heating element or gas burner head.

4,662,349; 5,163,359; 5,891,498; US 2003/0213484 A1; 2009/0126714 A1; 2009/0145421 A1; and US 2013/0112088 A1 were all gas operated BBQ Smoker Grills with no system or need for managing ash and has little to no resemblance to my invention or design.

2004/0000303 is an upright barrel shaped outdoor collapsible BBQ grill, oven and smoker system that is fueled with charcoal and has a charcoal pan. The apparatus is mounted on a dolly to provide mobility but the overall design is in no way similar to my design.

US 2015/0004297 A1 (Pothetes 1/2015) patented an outdoor grill, oven and firepit unit that was upright (vertical) with three front doors to access various chambers of the apparatus. The unit consist of a firebox without any separate means of managing ash and no separate water box. The unit does not resemble most current conventional outdoor BBQ smoker grills, but is a common resemblance for a vertical smoker and therefore has very little in common with my design. D493, 328 S (Wood 7/2004) are US D586,608 S (May 2/2009) are both similar in concept to Pothetes’ invention. Additional vertical smokers/ovens/drums include: US D720,569 S (Hill 1/2015); US D760,531 S (Scheer 7/2016); US D826,619 S (Measom et al. 8/2018); 462,923 (Gibbons 11/1891); US 2016/0235078 A1 (Farina et al. 8/2016); and US 2005/0121018 A1 (Rosen 6/2005).

Rotisserie smokers found include US D674, 234 S (Todd 1/2013).

Pat. Number 6,155,248 (Schlosser et al. 12/2000) is a traditional round shaped three-legged backyard grill with a removable ash catcher cup feature.

PARTS LIST

| Parts Number | Description |
|---|---|
| 10 11 12 13 14 15 16 17 18 19 20 21 22 23 24 25 26 27 28 29 30 | apparatus base cabinet wheels lid side shelf/tray shelf support coal drawer/fire box drawer pulls front shelf/tray shelf support water box/drawer ash box/drawer knock out base cabinet pull grill vent corner block or brace drawer supports/rail grilling grates hinges Perforated sheet metal floor cooking chamber |

DETAILED DESCRIPTION OF THE PREFERRED EMBODIMENT

I claim:

1. A coal, wood or pellet fired grill smoker with racks for cooking meat products comprising of:
a. a metal cabinet with separate sliding drawers located within the cabinet for holding, replenishment and/or disposal of:
i. Water or other liquid used for producing steam;
ii. Charcoal briquettes, wood or other fire, heat and/or smoke producing substances;
iii. Ash residuals from coal, wood or other fire or heat producing substances;
b. drawers for independently managing aspects of the cooking process;
c. a rounded metal top for circulation and convection of hot air, heat, steam and smoke.

2. An integrated steam and smoker, fire and ash management system comprising of:
a. a removable steam and smoker drawer with interconnected high V-channels which hold water or other liquid substances used for producing steam and/or smoke which:
i. holds the liquid used to produce steam;
ii. allows the liquid to be heated to a vapor by a fire or heat producing substance located beneath;
iii. allows fire and heat to pass through directly to the drawer to the food product to be cooked;
iv. collects some runoff juices and fats from meats and foods
v. provides for the removal of such embodiment when the user chooses not to use smoke or steam during the cooking process or wants direct heat, fire or flame in cooking;
vi. Positioned above the fire drawer or box.
b. a removable fire/combustion drawer consisting of:
i. a metal bottom panel or floor with perforated holes, expanded metal screen or grid panel for air flow to feed combustion and separate ashes out and away from the combustion chamber; and
ii. a combustion box for replenishing heat and smoke producing materials such as but not limited to charcoal briquettes, split or whole natural or artificially-made wood logs or other such fire creating materials;
iii. a position or location below the water drawer box and above the ash drawer box.
c. a removable ash drawer consisting of:
i. a solid metal bottom panel or floor which may have a limited number of holes for water drainage;
ii. a drawer that can be removed during or after the cooking process to empty or remove residue and ashes from burning wood or other fire producing materials;
iii. A position below the fire/combustion drawer box.
